(19) United States
(12) Patent Application Publication
(10) Pub. No.: US 2003/0197770 A1
(43) Pub. Date: Oct. 23, 2003

(54) Card cartridge and card feed adapter for an ink jet sheet feeder printer

(76) Inventors: Gary M. Klinefelter, Eden Prairie, MN (US); Martin A. Pribula, Eden Prairie, MN (US); Leonid S. Gershenovich, Eden Prairie, MN (US); Stacy W. Lukaskawcez, Shakopee, MN (US)

Correspondence Address: WESTMAN, CHAMPLIN & KELLY, A PROFESSIONAL ASSOCIATION, INTERNATIONAL CENTRE, SUITE 1600, 900 SECOND AVENUE SOUTH, MINNEAPOLIS, MN, 55402-3319, US

(21) Appl. No.: 10/126,439

(22) Filed: Apr. 19, 2002

(51) Int. Cl. B41J 2/01

(52) U.S. Cl. 347/104

(57) ABSTRACT

A conventional ink jet printer is modified to print identification cards by removing the paper feed assembly from the printer and substituting a card feeder. The card feeder has a frame that supports card feed rollers, and also supports the existing printer paper drive roller shaft. The paper feed drive shaft from the printer is used to drive the feed rollers for the card feeder. The initiation feeding a card is in response to the same mechanical input from the printer as was used to initiate feeding a sheet of paper for printing. The card feeder assembly does not add any motors or operating mechanisms to the printer, thereby maintaining a low cost by using a high production paper printer modified to accept identification cards.

### CROSS REFERENCE TO RELATED APPLICATIONS

Reference is hereby made to the following related co-pending applications filed on even date herewith: application Ser. No. 10/______, entitled “IDENTIFICATION CARD PRINTER HAVING MULTIPLE CONTROLLERS,” for inventors Gary W. Klinefelter, Leonid S. Gershenovich, Gary A. Lenz; and Robert E. Francis, having Attorney Docket Number F12.12-0109; application Ser. No. 10/______, entitled “IDENTIFICATION CARD PRINTER,” for inventors Martin A. Pribula, James R. Meier, Stacy W. Lukaskawcez, Gary M. Klinefelter, Leonid S. Gershenovich, Gary A. Lenz, and Jeffrey D. Upin, having Attorney Docket Number F12.12-0110; application Ser. No. 10/______, entitled “CARD CARTRIDGE,” for inventors Martin A. Pribula, James M. Meier, Stacy W. Lukaskawcez, Anthony L. Lokken, Gary M. Klinefelter, Gary A. Lenz and Jeffrey D. Upin, having Attorney Docket Number F12.12-0111; application Ser. No. 10/______, entitled “CARD TRANSPORT MECHANISM ROLLER SUPPORT,” for inventors Martin A. Pribula and Gary M. Klinefelter, having Attorney Docket Number F12.12-0112; and application Ser. No. 10/______, entitled “IDENTIFICATION CARD PRINTER DATA ENCODER MODULE,” for inventors Darrell T. Olson and Matthew K. Dunham, having Attorney Docket Number F12.12-0115. All of the above-referenced applications are incorporated herein by reference in their entirety.

### BACKGROUND OF THE INVENTION

The present invention relates to an ink jet sheet feed printer that is provided with an identification card cartridge and card feed, so it can be used for printing information on the identification cards, utilizing the drive motors and print control systems of the ink jet printer.

Ink jet printers have been found to do a satisfactory job of printing on identification cards, and low cost ink jet printers are available. These ink jet printers are generally provided with paper sheet feeders, which usually will feed individual paper sheets such as 8½×11″ or A4 size. The sheets thus are flexible and wide. The feed roller drive on the printer is designed for such wide sheets.

The printhead and the sheet roller drives, however, are relatively low cost, but very accurate and easily controlled.

Identification card printers have also been advanced, but they generally are specifically designed for printing standard size cards to include their own printheads as well as the card feeders.

The present invention takes advantage of the cost benefits of high production paper printers by providing a card feeder using a minimum number of replacement parts to adapt the sheet feed printer to print identification cards.

### SUMMARY OF THE INVENTION

The present invention relates to a identification card storage cartridge and card feed assembly that can be mounted as a sub-assembly onto a base of a paper sheet printer, preferably an ink jet printer, and which utilizes the motors of the ink jet printer to feed I.D. cards to and through the printhead position for printing on the cards.

The conversion from a paper sheet printer to an identification card printer uses the printer paper feed drive shaft that drives rollers for feeding the paper. The rollers and all of the paper feed mechanism is removed and a frame that mounts a card cartridge and card feed roller is attached to the printer base. The card feed rollers are positioned substantially in the center of the print area of the ink jet printer when used for paper sheets. The card feed is driven by the existing motor on the printer that drives the drive shaft for the normal paper feed rolls on the printer.

The card feed rollers include a card start roller driven by a mechanical drive initiated by a mechanism on the printer. The card feed rollers transport the card and support the card in a level plane beneath the ink jet printheads, so that the printing can be carried out on the card from edge to edge and end to end.

Sensors for sensing when a card is in the printing position and for sensing when the cover is closed can be provided, and these will be used to provide signals to the existing sensors on the printer. The card feeder adapter sensors provide signals indicating that the conditions to be met by the printer sensors have been met, when the card feeder and card are in proper position. The original printer controller is used to control the print operations, with a separate master card feed controller for providing suitable signals for initiating the print operation.

The frame of the card feeder adapter or assembly is mounted right onto the base plate of the printer, and fits into the region where the printheads are moved for printing. The existing paper sheet feed rollers are removed from the paper sheet feed drive shaft and a gear for driving the card feed or transport rollers is added. The existing drive motor for the sheet feed drive shaft is used for driving the drive shaft. The drive shaft is mounted at least some of the existing guides on the printer. The card feeder assembly or adapter frame supports bearings that mount the printer sheet feed drive shaft to hold it in position. The bearings are mounted so they will float for alignment. The bearings can be mounted on the drive shaft, with the card feeder assembly frame moved into position, but unsecured, and once the bearings are adjusted and held along the length of the sheet feed drive shaft in the proper position, the card feeder assembly frame can be fixed to the base of the printer to locate it positively in position and without having misalignment problems.

The speed of the motor for the printer sheet feed drive shaft can be changed by changing an encoding wheel that is used for providing information relating to the speed back to the main controller. One can change gear ratios to accommodate different card feed roller diameters. Suitable sensors can be used and connected into the existing sensors on the printer to provide signals to the sensors for the printer that are tied in with the printer controller. The separate sensors provide signals to indicate the card is properly positioned on the identification card feeder and the card transport mechanism. New control buttons controlling existing printer button inputs to the printer controller can be provided.

A master controller operating through a USB hub is added for the modified printer to control card feed and to manage the existing controls on the printer. Security or identification tags on the card cartridge used and/or on the printheads provide signals to the added master controller for use. The security signals provide impulses so the master controller can control supplies and ensure the card cartridge contains authorized cards and the printheads are authorized as well.

### BRIEF DESCRIPTION OF THE DRAWINGS

FIG. 1 is a perspective view of the outer housing of a conventional ink jet printer having a card feeder made according to the present invention installed thereon;

FIG. 2 is a rear perspective view with the cover removed, showing the conventional printer frame, and the card feeder assembly of the present invention installed therein.

FIG. 3 is a perspective view of from the front side of the printer with the cover removed, showing the conventional ink jet printheads, frame, and guide rod, and showing the card feeder frame and rollers that support the card during printing;

FIG. 4 is a front perspective view of a card feeder frame and cartridge, removed from the printer frame, showing the conventional printer drive shaft mounted on the card feeder frame;

FIG. 5 is a sectional view as on line 5—5 in FIG. 4;

FIG. 6 is a view from the opposite side of the frame shown at FIG. 5, illustrating a drive belt used for carrying drive power back to the card feeder cartridge;

FIG. 7 is a rear perspective view of the card feeder frame with the card feeder cartridge removed;

FIG. 8 is a perspective view of a dual top roller pinch assembly used for holding a card being fed in a plane and held properly for printing;

FIG. 9 is a sectional view taken on line 9—9 in FIG. 8;

FIG. 10 is an enlarged fragmentary top view showing a bearing mounting for the sheet feed shaft in the card feeder frame;

FIG. 11 is a side view of FIG. 10;

FIG. 12 is a top plan view of a sensor on a printer used for determining a physical position of a component, such as a leading edge of a paper sheet, modified to work with a sensor input used for the present invention; and

FIG. 13 is a block diagram of a control system for the present invention.

### DETAILED DESCRIPTION OF THE ILLUSTRATIVE EMBODIMENTS

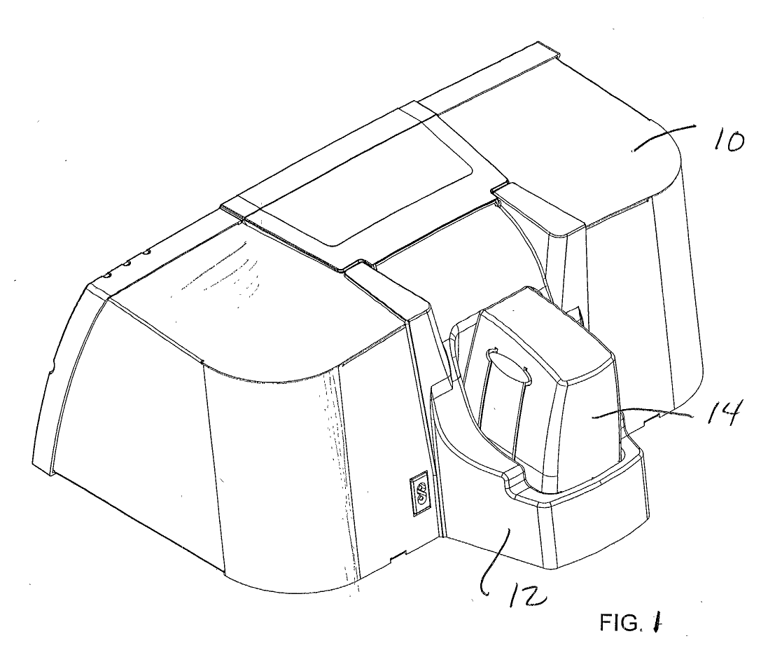

In FIG. 1, an exterior view of a conventional ink jet printer 10 is shown, and it is modified to change the cabinet to accommodate a card feeder adapter assembly 12, including a card cartridge 14, which will feed cards to card feed rollers for transport to the printing location for ink jet printheads. The printer is a Hewlett Packard Model No. 940 ink jet printer. The components that are part of the conventional, commercially available printer used in the present invention, including the printer frame, printheads, printhead drive and printer controls are not shown in great detail, because the printer is commercially available.

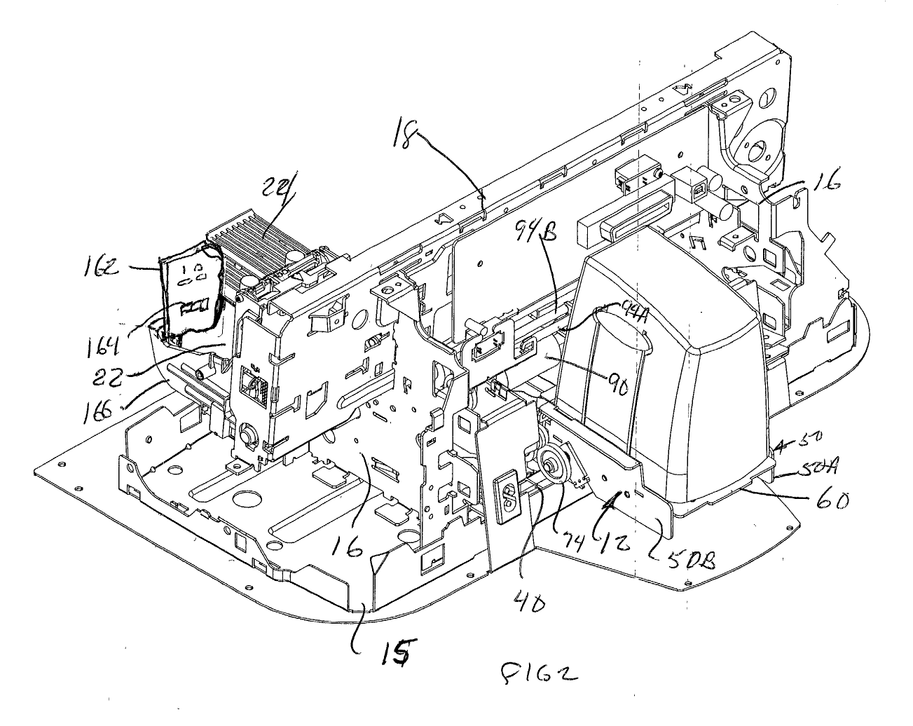

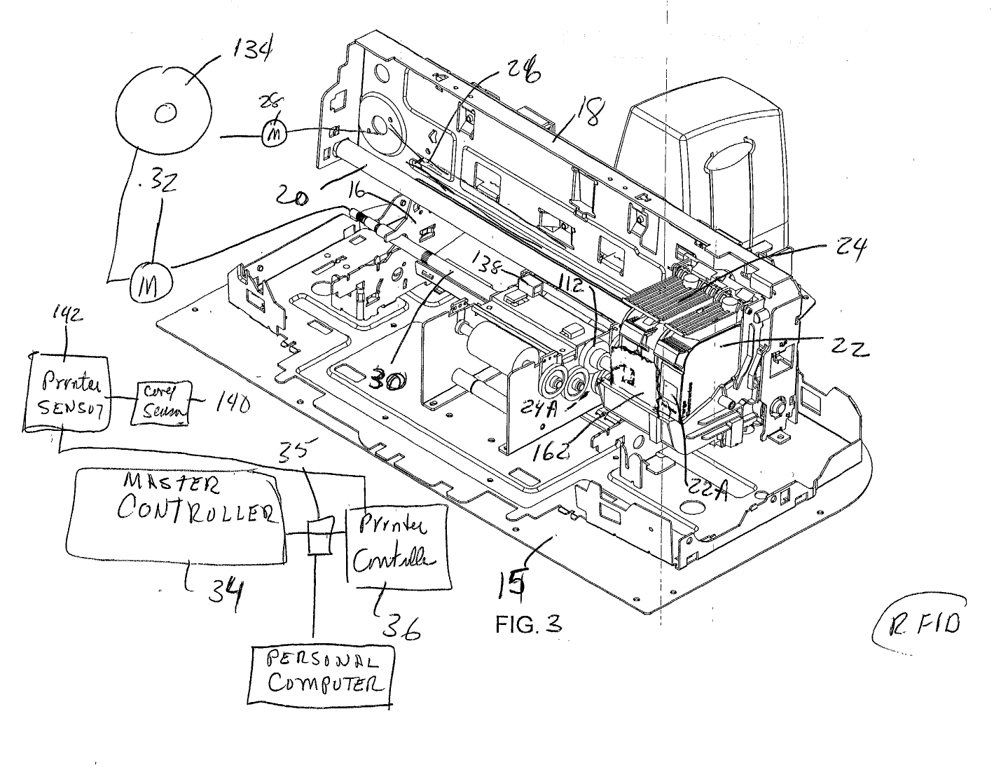

The cover or housing of the printer has been removed in FIGS. 2 and 3. As shown, a base plate 15 of the printer supports upright printer frame member 16, and a main printer cross frame 18. The paper feed tray, the paper feed, and the paper sheet singulator are removed, and as shown in FIG. 3, a card feeder assembly 12 is placed in the center portion of a region. The main frame 18 supports a printhead guide and support shaft 20 in a conventional manner. The printheads 22 and 24 are conventional Hewlett Packard printheads having replaceable ink cartridges. The printheads are driven as a unit along the shaft 20 using a suitable belt drive, illustrated schematically at 26, and a printhead motor 28 illustrated schematically for driving the belt. The motor 28 is controlled so that it will move the printheads 22 and 24 rapidly along the guide shaft 20, and in either direction of movement, by reversing the drive to the belt 26. The belt 26 is shown only schematically because it is conventional on ink jet printers made by Hewlett Packard Corporation for driving the printheads.

In FIG. 3, a main printer sheet feed drive shaft 30 is illustrated, the shaft comprises the paper sheet feed drive shaft in the conventional ink jet printer. In order to accommodate the card feeder adapter assembly 12, the relatively large diameter rubber sheet feed rollers that are normally on the shaft 30 are removed, and roller guides that are not needed for supporting the shaft 30 directly are also removed from the printer frame 18. A drive gear 112 is added to shaft 30 for driving a card transport or feeder, as will be explained. The shaft 30 will be guided as needed and will be supported on side plates 50A and 50B of the frame 50 for the card feeder assembly. The shaft 30 is driven by a motor 32 through a suitable gear set. The motor 32 can be controlled with a master card feeder controller 34 through an existing printer controller 36. The controller 34 is connected through a USB hub to the existing printer controller 36, which actually controls the motor 32.

The paper feed shaft drive motor 32, and the printhead motor 28, as well as the drive belt 26 and the printheads are all on the original printer, and the shaft 30 is the existing paper feed roller shaft for feeding paper in the Hewlett Packard 940 printer.

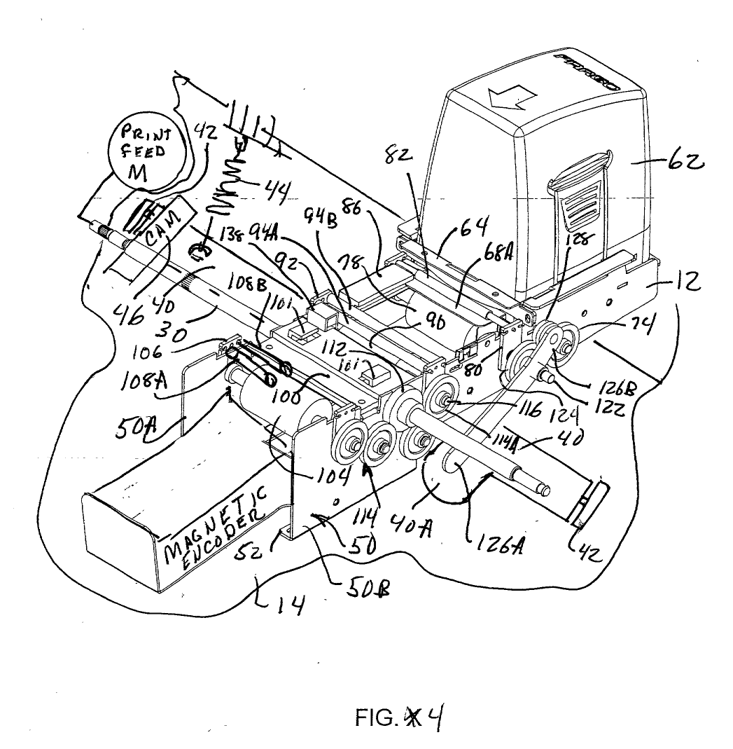

The printer base plate 15 mounts a conventional sheet feed pivoting frame that is used for initiating the feeding of sheets of paper from a paper supply. The pivoting frame 40 is a plate pivotally mounted about a horizontal axis on suitable supports indicated at 42 schematically on the printer base 15. The actuator 40 is spring loaded so that an actuator tab portion 40A that is formed outwardly from the main portion of the actuator pivoting frame is spring loaded upwardly with a suitable spring 44, that is attached between the actuator pivoting frame and the frame 18 as shown schematically in FIG. 4.

The actuator pivot frame 40 and tab 40A are normally held down adjacent the face plate 40A against the action of the spring 44 with a single revolution cam 46. In the rest position, the cam 46 will hold the actuator pivot frame 40 downwardly against the surface of the plate 15 of the printer. When a print command is received by the printer controller, the shaft 30 is driven by motor 32, and this drives the cam 46 in a single revolution in a known manner. During a portion of the single revolution, the actuator pivot frame 40 is released so that the tab member 40A moves upwardly, as urged by the spring 44. The time that the tab 40A remains in position is determined by the speed of rotation of shaft 30, and the portion of the revolution that the cam releases the actuator pivot frame.

This time is sufficient to initiate the feed of one sheet of paper, or with the present invention, one card. The cam 46 returns to its position holding the tab or actuator 40A downwardly during the last part of its rotation and the tab remains in that position during the printing on a card that is fed by the card feeder. In other words, the shaft 30 can continue to rotate after the cam has made one revolution, but the cam will not move until it is reset. The cam is reset by movement of the printheads to the end of the guide shaft 20 adjacent the motor 32.

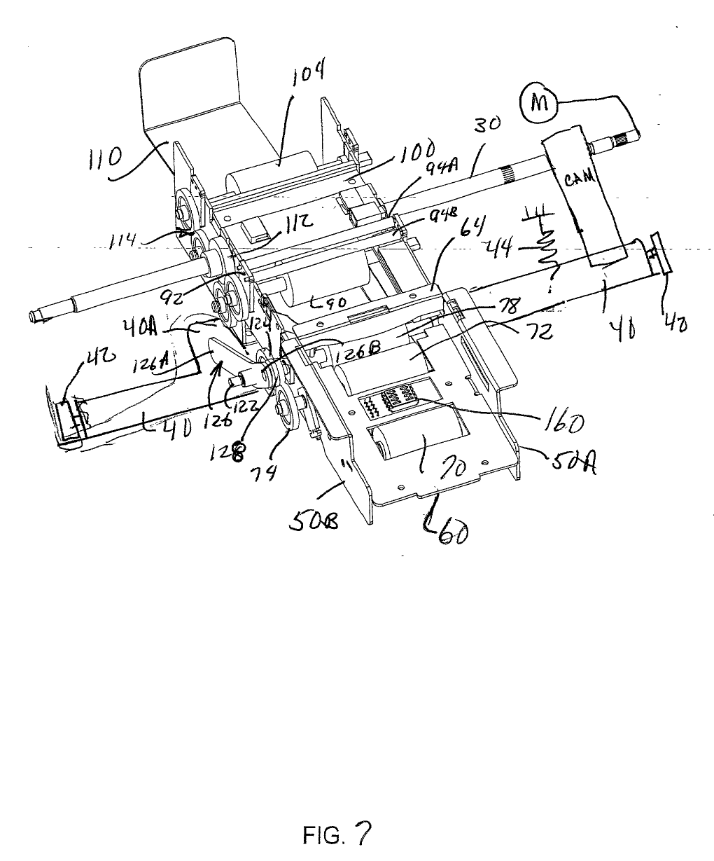

The feeder assembly 12 is perhaps best shown in FIGS. 4, 5, 6 and 7. The card feed adapter assembly 12 includes a frame 50 that is formed with side plate members 50A and 50B which can be held together with cross members such as cross member 60 (FIG. 7) in a suitable manner. The side frame members 50A and 50B have bottom flanges 52 that are used for fastening the side frame plate members 50A and 50B to the base plate 15 of the printer.

The showings in FIGS. 4 and 7, for example, illustrate the drive shaft 30 in position on the frame 50, as an initial step in converting an existing printer to use frame 50. After removing the paper supply and paper feeder from the printer to accommodate the card feeder assembly, the shaft 30 is removed from the printer frame along with the large diameter rubber paper or sheet feed rollers. The paper feed rollers are removed from the shaft as well. Various drive components that are used for driving the single revolution cam previously mentioned are replaced on the shaft 30. Shaft 30 is used as the drive input for the card feeding, as will be explained.

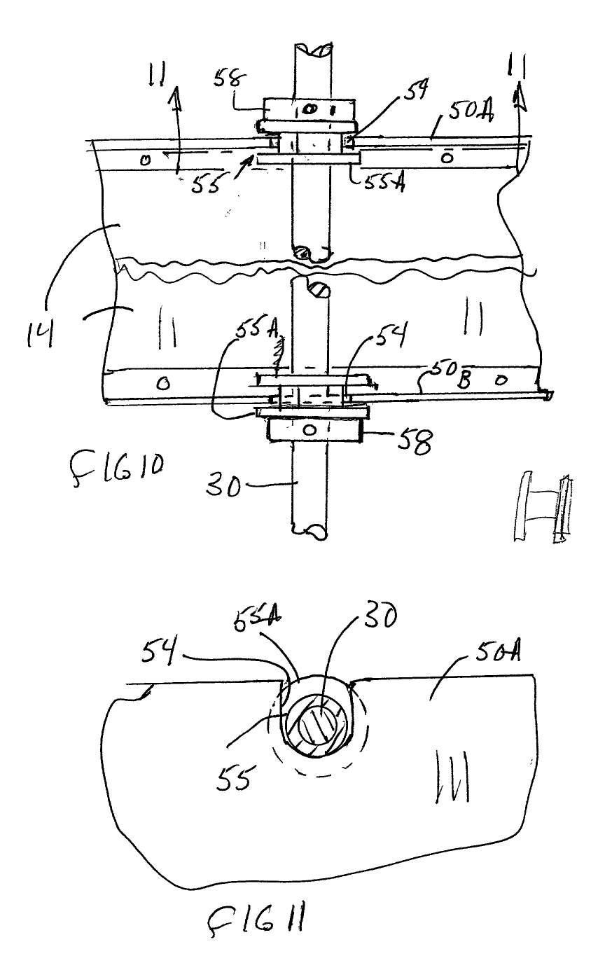

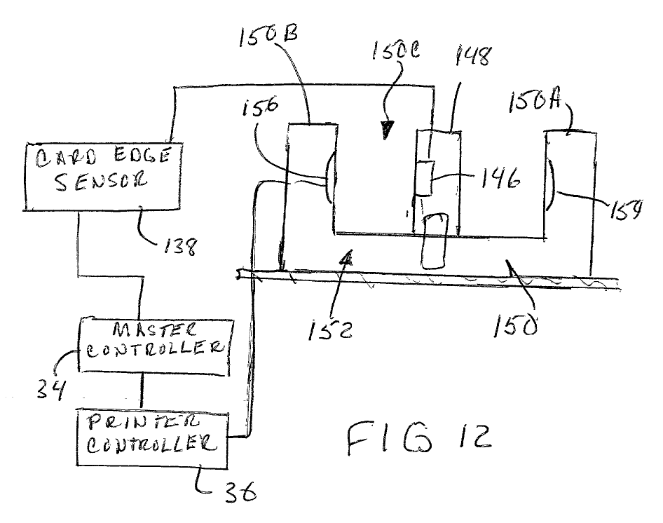

The shaft 30 is supported in U-shaped upwardly open notches or slots 54 at the upper edges of the side plate members 50A and 50B. As shown in FIGS. 10 and 11, each of the side plate notches 54 is of size to receive a bushing 56. The bushings 56 each have a center annular groove 55 that forms side flanges 55A fit on opposite sides of the respective side plates 50A and 50B and the groove permits the bushings to slide into the notches or slots 54. The bushings will not move relative to the side plates in an axial direction of the shaft 30, but can slide up and down.

The shaft 30 is axially held in place relative to the bushings 56 with suitable lock collars 58, as shown in FIG. 10, so that the shaft cannot remove axially relative to the side frame members, but the slots 54 permits some vertical movement relative to the shaft.

It should be noted that the side plate members 50A and 50B can be held with additional suitable cross supports in addition to the cross support shown at 60, and the cross supports can be placed where desired to hold the frame in an assembly.

Side plate members 50A and 50B extend in fore and aft direction of the card feeder assembly, and have a rearward portion that supports a card cartridge 62, that is of conventional design. The card cartridge 62 has an outlet opening 66 on an output side thereof near the bottom. A “singulator” plate 64 is positioned to overlie the opening, as shown in FIGS. 4, 5 and 6 to control the gap or opening 66 for the cards. The card cartridge 62 holds a plurality of individual cards 68 in a stack in a normal manner, and these cards can be fed by gravity, or light spring force downwardly toward card support and drive rollers.

As shown, an idler card support roller 70 is rotatably mounted between the side plates 50A and 50B, and it is to support trailing or rear portion of a card 68A in a suitable plane when the forward portions of the card are supported on an initializer or card start roller 72 adjacent the opening 66. The card start feed roller 72 is supported between the side plates 50A and 50B, and is driven through a suitable gear 74 on the exterior of the side plate 50B as shown in FIG. 4. The singulator plate 64 can be raised and lowered to accommodate different card thicknesses, if desired.

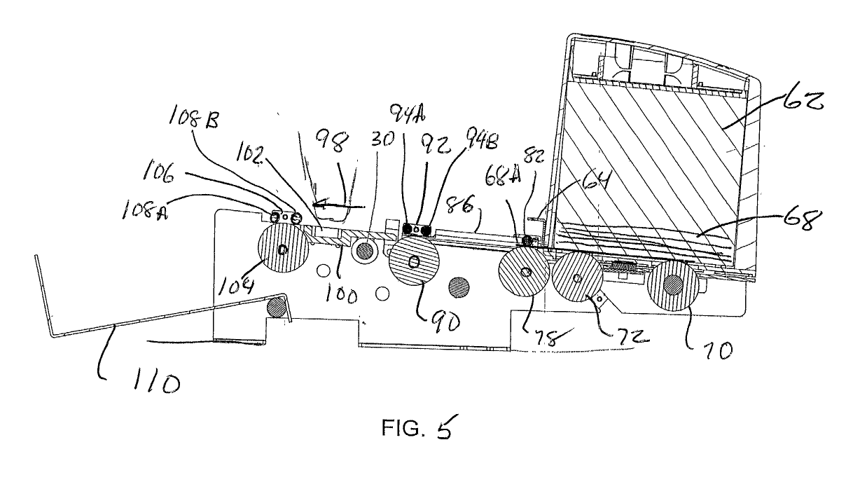

The card transport or assembly 12 is formed as a subassembly, and a first card guide and support roller 78 is positioned just to the exterior of the outlet opening 66, as shown in FIG. 5. This guide and support roller 78 is rotatably mounted on suitable bearings on end plates 80 supported on the exterior of the frame side plates 50A and SOB. End plates 80 have upwardly projecting ends that support a smaller diameter pinch roller 82 that is positioned to be closely spaced from the outer surface of the first drive roller 78, to pinch an exiting card shown at 68A and provide a drive after the card has once been initialized or started by driving the card start roller 72, which is an initial feed roller.

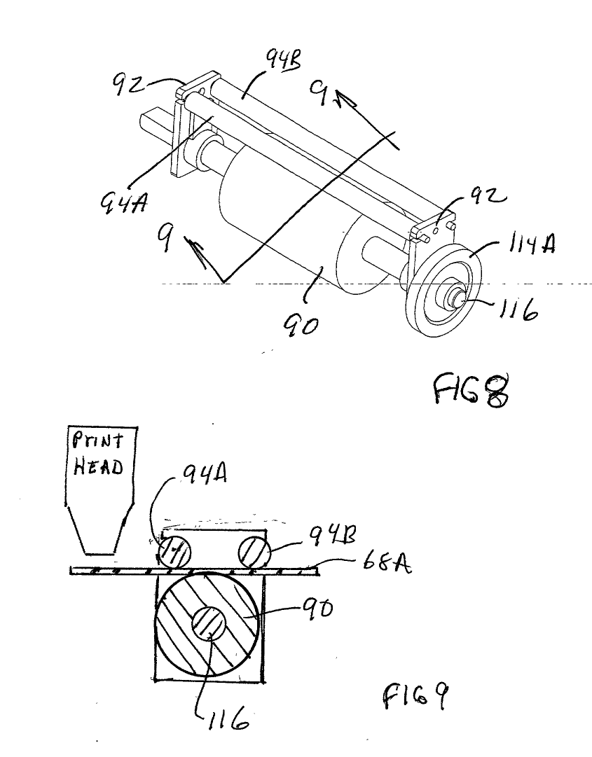

The card 68A, as shown, is guided in at least one suitable edge guide 86 that receives the edge of the card and provides a track that guides the card toward a second card feed and support roller 90. The second card feed and the support roller 90 is supported on suitable end plates 92, which in turn are mounted on the side plates 50A and 50B. The end plates 92 in this form of the invention protrude above the side plates 50A and 50B and mount a pair of pinch rollers 94A and 94B that are spaced apart in the longitudinal direction of travel of the card 68A as the card is fed. The peripheries of these two pinch rollers, as shown in FIG. 5 and also in FIG. 9, provides a stabilizing support plane for a card passing through the roller 90 and being driven by the roller 90. The pinch rollers 94A and 94B stabilize the card and hold it on a generally horizontal plane tangent to the bottom of the pinch rollers. The pair of pinch rollers prevent the card from cocking or tilting, as can occur with a single pinch roller such as that shown in connection with roller 78 and pinch roller 82, if the card is supported on only one roller.

It can be seen that as the card is fed in its normal longitudinal feed direction indicated by the arrow 98, the card 68A will overlie a shield 100 that is supported on the side plates 50A and 50B, and which is positioned over the shaft 30, and underneath the path of the printheads. An ink collecting well 102 is formed in the center portions of this shield 100. The card 68A is held in a position spaced above the shield so that as the card is being printed, it is cantilevered out from the second drive roller 90 and its pinch rollers 94A and 94B. The pinch rollers stabilize the card 68A so that it can be printed upon by the ink jet printers as they spray ink onto the card surface right up to the edges of the card. A pair of short edge guides 101 can be provided as desired.

A third card feed roller 104 is rotatably mounted on the side plates, and also is powered. This has end caps 106 that in turn also support a pair of pinch rollers 108A and 108B, positioned and operating in the same manner as the pinch rollers 94A and 94B in connection with the drive roller 90. The reason, is that as the card passes through third feed roller 104, the trailing edge end of the card will be cantilevered over the support 100 while printing occurs from the printhead traveling transversely in a path that is aligned with the ink well 102. The rollers 108A and 108B stabilize the card and hold the trailing end that is cantilevered out, so that the complete printing job can take place before the card is driven forwardly far enough to fall into a card cartridge 110.

As was stated, the shaft 30 is used as a power drive for the card feed mechanism, and this is accomplished by providing a gear 112 drivably mounted on the shaft 130 on the exterior of the side plate member 50B, which in turn meshes with suitable gears forming a gear train 114. The gear train 114, as shown, includes four gears, and the gear 112 will then, through this gear train, drive the roller 104, and the roller 90 by direct gear drive.

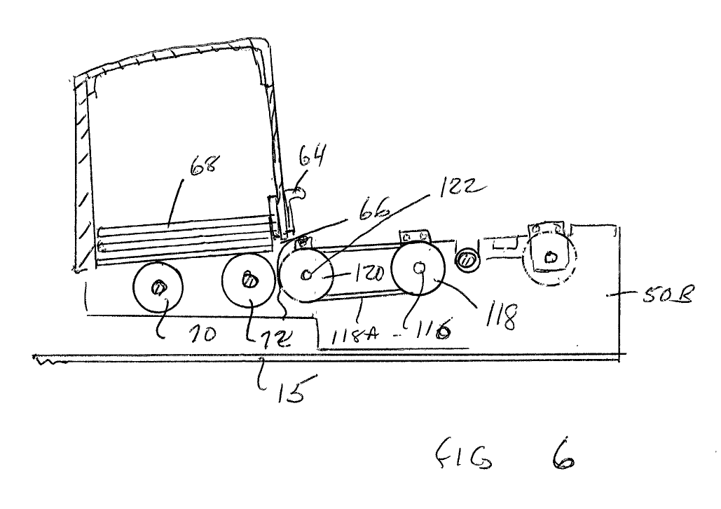

The roller 90 has a central shaft 116 driven by gear 114A of the gear train 114, and shaft 116 spans the side plate members 50A and 50B, and extends out beyond the support end plate 92 on the exterior of the side plate member 50A. As shown in FIG. 6, shaft 116 has a pulley 118 thereon, that drives a belt 118A, to in turn drive a second pulley 120 mounted onto a shaft 122 that is used to mount the first card drive roller 78. The shaft 122 extends across the frame to the outside of the side plate 50B. The shaft 122 has a gear 124 thereon, and the shaft 122 also mounts a pivoting lever 126. The pivoting lever 126 has an outer actuator end 126A that overlies the actuator tab 40A of the pivot frame or plate 40 of the printer. The lever 126 also has an opposite end 126B that mounts a gear 128. Gear 128 is an idler gear that is rotatably mounted on a center shaft held on the lever 126 at end 126B. The gear ratios in the gear drive train 114 can be changed to accommodate different diameter card feed or transport rollers.

When the pivot frame of plate 40 is being held down by the actuator cam 46, as previously explained, the gear 128 clears gears 124 and 74, so that the gear 124 can merely spin while the roller 70 drives a card without affecting the gear 74 and the card start feed roller 72. When the cam 46, which as explained is a single revolution cam, rotates through its one revolution, during a portion of that rotation, it releases the pivot frame plate 40 and the actuator 40A pivots upwardly causing the end 126A to move upwardly and the 126B of the lever 126 to move downwardly toward the gears 124 and 74.

When the gear 128 meshes with both gears 74 and 124, gear 74 is driven for a limited time (while the cam 46 has released the frame of plate 40) to initially drive the card start roller 72 and pick the bottom card 68 off the stack of cards in the cartridge, send it through the opening 66 under the singulating gate 64, so that it is engaged by the first drive roller 78 and pinch roller 82. The card 68A that is shown in FIG. 4, is driven forwardly in its path toward the second drive roller 90.

The cam 46 moves the pivoting frame tab 40A to its rest position causing the lever 126 to retract gear 128 from the gears 124 and 74 disabling the drive to the card start roller 72 in the card cartridge before a second card is fed. In other words, the cam 46 only is operable to permit rotation of the roller 72 to initiate or start movement of the card until it is engaged by the first card drive roller 78.

The card 68A is held between the drive roller 78 and its pinch roller 82 as shown in FIG. 4, for example. The card then will be fed forward continuously and the feed start roller 74 will not be driven any longer.

In order to control the printing, a central or master controller 34 is used as previously explained, and it operates through a USB hub 35 (See FIG. 13), to connect to and control the printer controller 36 which is the standard printer controller for controlling the printheads 22 and 24 in connection with a printing program that is inputted. The program is set for printing the material onto the cards being fed through the card feeder. A personal computer 37 can provide the overriding control and program from the card feeder and printer. The printer inputs (buttons or touch screen) are redirected from the printer controller to the master controller 34. The hub can be connected to accessories, such as a magnetic encoder 39. The use of a USB hub and a master controller can add control features, such as test and security signals 160A from a sensor 160 that will be shown. Also signals represented at 162A from a printhead security sensor circuit, as will also be shown can be provided. The master controller 34 controls the printer controller, and the printer controller operates the printheads and the card feeder.

The operation of the cam 46 is mechanical, but it is synchronized with the card drive through the controllers 34 and 36 by determining the position of the drive motor 32 through the use of a suitable encoder assembly 134 shown schematically. The printer has sensors for determining paper position adjacent the printing station, and also has a sensor indicating the cover is closed. This is to insure that the printer will not be operated with the cover open.

The card feeder assembly also includes a cover and a cover sensor, and a sensor shown at 138 is provided for sensing when the leading edge of a card is at a location to be synchronized with the printing operation. The sensor 138 is used in connection with the existing sensors on the printer in a unique manner. The sensor for the card printer cover, which is shown schematically at 140 is also properly positioned, and is tied in with the existing printer cover sensor 142.

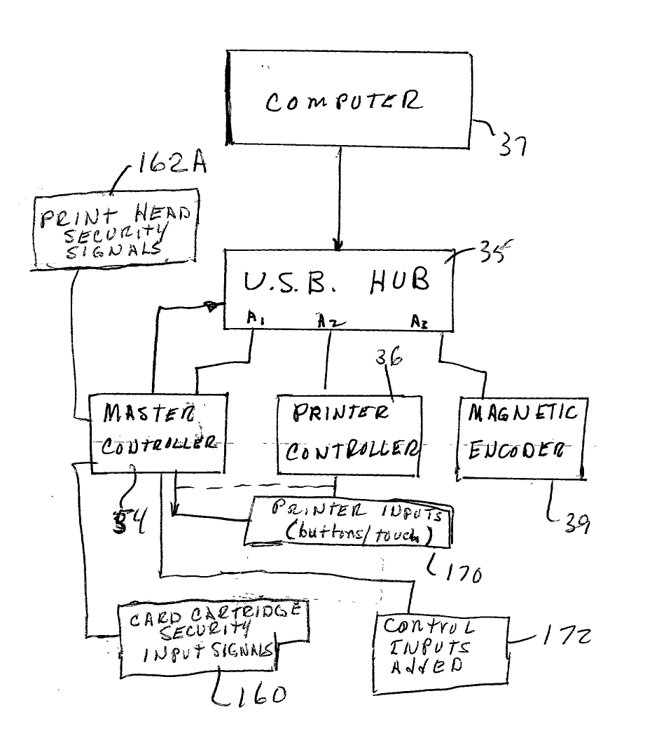

The existing paper edge sensor of the printer is schematically illustrated in FIG. 12, and it is wired into the printer controller 36 to provide signals when the paper edge is sensed. The paper edge sensor 152 comprises a housing 150 that has two legs 150A and 150B that are spaced apart to form a gap 150C. A LED light source 154 is mounted on 150A of the housing 150, and a light receiving diode is mounted on 150B. The light emitting diode and the light receiving sensor 156 face each other across gap 150C when the printer is printing paper sheets.

In order to use this sensor 152 without changing the inputs to the printer controller 36, the card edge sensor 138 is connected to a light 146 mounted in a block 148. The block 148 is in turn clipped or otherwise mounted on the housing 150 for the paper edge sensor 152 that is provided with the printer. The block mounting light 146 is positioned between legs 150A and 150B, so that the light emitting diode 154 never provides light to the light sensor 156 when block 148 is in place.

The light 146 of block 148 will provide such light when it is on, and when the card edge sensor 138 senses a card edge, the card edge sensor provides a signal to turn off the light 146. The printer sensor 152 then provides a signal indicating that the substrate to be printed on, in this case an I.D. card, is in proper position.

This is essentially a pseudo sensor that be tied into the existing sensors on the printer. The same arrangement is used for the card feeder cover sensor 140 and the existing printer cover sensor 142. When the light 146 turns off, signaling that a card is being fed and is in an indexing position, the sensor 152 initiates the printing cycle in a normal manner through the print controller 36.

As shown in FIG. 7, where the card cartridge 62 is removed, the cross plate or support plate 60 is illustrated in more detail, and has a suitable opening for the card supply idler roller 70, and for the card start roller 72, as shown. Additionally, there is an opening through which a security sensor 160 extends. The security sensor 160 will mate with suitable contacts on the card cartridge when the cartridge is in place are to provide for an indication that the correct cards are held in the cartridge, and that they are authorized cards. Other security measures can be transmitted through the sensor 160 to the master central controller 34 before printing operation starts. If the cards in the cartridge 62 are bootleg or unauthorized, the printer would be locked up and would not print.

As additional security/identification of components, the printheads 22 and 24 can carry RF identification tags 22A and 24A shown in FIG. 3, and a security circuit board 162 having an RF antenna 164 (FIG. 2) is mounted on a frame portion 166 to sense signals from the RF tags and if the signals indicate a proper, authorized printhead the circuit on board 162 provides a signal to the master controller to indicate authorized printheads/ink cartridges are in place. Thus two sets of security or ID signals are provided for operation.

The card feeder assembly 12 is formed apart from the printer generally as shown in FIGS. 4 and 7, except the plate or shield 100 and the shaft 130 are not put into place on the initial assembly.

Once the frame 50 is assembled, the shaft 30 is slid into the slots in the side plates 50A and 50B, and the collars 58 are adjusted so that the shaft 30 is properly located relative to the drives needed for the printer. The collars 58 are then locked in place, for example with set screws, so that the bushings 56 are held in the side plates and will hold the shaft 30 in its proper axial position. The frame assembly 50, with the rollers for driving the cards in place, is then slid into the opening in the printer formerly occupied by the paper drive, and the shaft 30 is located in the supports on the printer frame that supported the shaft 30 before removing the paper drive.

Then, the flanges 52 are secured down to the base plate 15 with suitable screws, and any misalignment that has occurred is accommodated by the U-shaped slots 54 holding the bushings 56. The bushings 56 can slide up and down, and will not place a load on the shaft 30. They also can take some other misalignments, but primarily in the vertical direction, they will permit the shaft to seek its own level, and yet be supported.

Once the card feeder assembly 12 is in position, it will be integrated with the existing printer, as shown a Hewlett Packard Model No. 940 printer, and the master controller 34 will provide commands to the printer controller 36 when suitable conditions are met, so that the printer controller will operate to provide printing on cards in the same manner as printing paper sheets for previously done with the printer. The frame 50 mounts the existing sheet feed roller drive shaft 30, which is modified by adding a gear to drive a gear train for the card feeder. Intermittent operation of the card start roller 32 which initializes the feed of a card is provided through a simple lever that engages a pivoting cam follower plate operated by the printer in the normal manner that the printer operates.

In addition, the card feeder rollers stabilize the card so that it can be cantilevered underneath the printhead and will not need to engage a platen or other support that may scratch or abrade the surface of the card.

If the card has a magnetic strip, that strip can be encoded with a suitable add on encoder 39 in place of the card cartridge, as shown schematically in FIG. 4.

If the card has an embedded integrated circuit (IC) (a smart card) also can be encoded with an encoder added as shown at 39, either using a radio frequency encoder or a direct contact encoder of known design.

In FIG. 13, the printer inputs 170 can be buttons or touch screen inputs on an existing printer. The control inputs added shown at 172 can be new command buttons used for card printing or commands from the master controller that provide signals to the signal lines from the printer inputs to the printer controller. The printer controller recognizes the signals as if they were commands from the printer inputs and operates the printer accordingly. Thus, new inputs can be used to “fool” the printer controller by substituting desired signals along the same control lines as the printer inputs.

While ink jet printers have been mentioned, the conversion will also work for other types of printers, and also with other makes and models of ink jet printers.

Although the present invention has been described with reference to preferred embodiments, workers skilled in the art will recognize that changes may be made in form and detail without departing from the spirit and scope of the invention.

What is claimed is:

1. A card transport conversion assembly for an existing paper sheet printer having a printhead, a printer sheet feed drive, and a control for initializing feed of a printable sheet to the printer, the conversion assembly comprising a card transport for feeding cards to be printed, a drive link between the printer sheet feed drive and the card transport, and a conversion assembly support mounting the conversion assembly on the existing printer.

2. The card transport conversion assembly of claim 1, wherein the printer sheet feed drive includes a printer controller, a master controller for controlling the card transport, and a card sensor for sensing a condition of a card on the card transport, the card sensor providing a signal controlling an existing sensor on the existing printer.

3. The card transport conversion assembly of claim 1, wherein the paper sheet feed drive includes a drive shaft, and mounts on the conversion assembly support for mounting the existing printer drive shaft in a position substantially identical to the position on the printer of the drive shaft prior to mounting the conversion assembly on the printer.

4. A card transport assembly for an ink jet printer having a printhead, a printer sheet feed drive shaft, and a control for initializing feed of a printable sheet to the printer, the assembly comprising a frame mounted on the printer, a card transport device on the frame, a support for supporting the printer drive shaft on the frame, and a card transport drive from the printer drive shaft to the card transport drive on the frame.

5. The card transport assembly of claim 4, wherein said frame supports the printer sheet feed drive shaft in a position substantially identical to the position of the shaft of the printer prior to mounting the card transport assembly on the printer.

6. The card transport assembly of claim 4, wherein said frame comprises spaced apart side plates, said side plates having upper edges, and said printer sheet feed drive shaft being mounted on the side plates for rotation, and the printer sheet drive shaft being mounted to permit limited generally vertical movement relative to a support for the frame.

7. The card feeder assembly of claim 6 and attachment panels on the frame for securing the frame to a base plate of the printer with the printer drive shaft supported on the frame.

8. The card feeder assembly of claim 4, wherein said printer is provided with a sheet feed initializing movable plate, and wherein the card transport assembly includes a card transport drive actuator lever positioned to be engaged by the movable member, a sheet feed actuator permitting movement of the movable member to a first position under control of a printer controller, the actuator lever engaging a drive start the card transport drive when the movable member moves to its first position.

9. The card feed assembly of claim 8, wherein the card transport includes one card feed roller positioned adjacent the path of travel of printhead of the printer, said one card feed roller comprising a drive roller, and a pair of pinch rollers supported adjacent the drive roller to engage an upper surface of a card, and hold a card in a substantially planar position as the drive roller moves the card in its path toward the printhead path of travel.

10. The card feeder assembly of claim 4, and a card cartridge mounted on the frame, the card cartridge having a card feed outlet, and an end card in the card cartridge being engageable with the card transport drive.

11. The card feeder assembly of claim 10, and a security sensor mounted on the frame and positioned to sense a code contained on the card cartridge for identification purposes.

12. A card feeder assembly for an existing printer to replace paper sheet feed, comprising a frame, a card supply mounted on one end of the frame, card feeder rollers for feeding one card at a time from the card supply to a second end of the frame, a pair of feed rollers adjacent to the second end of the frame being spaced in direction of feed of a card to provide a printing station, the card feed rollers including a card start roller engaging a card to be fed from the card supply, all of the card feed rollers having drive mechanisms for driving the rollers, all of the card feed rollers except the card start roller being simultaneously driven when a power shaft coupled to one card feed roller is powered, a drive engaging member on the card start roller actuable to engage and be driven by an adjacent portion of the drive mechanism when a drive signal is received, the frame having mounting locations for a power shaft mountable on the existing printer.

13. The card feeder assembly of claim 12, wherein the drive mechanisms comprise a gear train between the card start roller and an adjacent other card feed roller, and wherein the drive engaging member comprises an idler gear between gears of the gear train, the idler gear moving from a position clearing the gears of the gear train in a non printing position to a position engaging the gears of the gear train to drive the card start roller when the drive signal is received.

14. The card feeder assembly of claim 12, wherein there is a lever mounted on the frame, the idler gear is mounted on the lever, the lever pivoting between the position clearing the gears and the position engaging the gears.

15. The card feeder of claim 12 in combination with a printer having a printer frame, the card feed assembly being mountable on the printer frame and the power shaft being mountable on the printer frame and driven by a motor on the printer frame.

16. The card feeder assembly of claim 15 wherein the printer is an ink jet printer, the ink jet printer having printheads that move over the printing station.

17. The card feeder assembly of claim 16 wherein the printer frame mounts a paper feed pivoting frame, the actuator lever engaging the paper feed pivoting frame, the printer providing a print signal to move the paper feed pivoting frame to a printing position and move the actuator lever to move the idler gear to the position engaging the gears of the gear train.

18. The card feeder assembly of claim 12, wherein said card supply comprises a card cartridge, said card cartridge having an identifiable code thereon, and a sensor on the frame positioned to sense the code on the card cartridge when the card cartridge is in place on the frame to provide a signal indicating the status of cards in the card cartridge.

19. The card feeder of claim 15, wherein the printer has printheads thereon, a sensor positioned on the printer to sense presence and conditions of identification indicia on the printheads and to provide a signal indicating that the printhead is acceptable.

20. The card feeder assembly of claim 19, wherein the sensor is a radio frequency sensor and wherein acceptable printheads include a radio frequency tag thereon.

21. A method of forming a low cost printer for printing identification cards by adapting an existing printer that normally prints on paper sheets to print on identification cards, comprising: removing from the existing printer a paper feed device; providing a card transport assembly in the place of the paper feed device for transporting cards to be printed from a source to a printhead on the printer; and linking a drive between a printer paper feed drive on the printer and the card transport for transporting cards to be printed

22. The method of claim 21 and transporting a card to be printed in response to a print initializing condition of the printer.

23. The method of claim 22 including providing a separate controller for the card transport assembly and controlling functions of a printer controller with the master controller.

24. The method of claim 21 including provides a sensor on the card transport assembly for sensing conditions pertinent to printing cards, and provides a signal to an existing sensor on the printer to provide signals from the existing sensor based upon signals from the sensor on the card transport.

25. A method of forming a low cost printer for printing identification cards by adapting an existing printer that normally feeds paper sheets for printing to print on identification cards, comprising: removing from the existing printer the paper feed device and removing feed rollers from a sheet feed roller shaft; providing a card feeder assembly including a frame, and card feed rollers for feeding identification cards to be printed from a source, mounting the sheet feed roller shaft on the frame, connecting a drive between the feed roller shaft and the card feed rollers, and initiating the drive to start feeding a card in response to a print initializing condition of the printer.

26. The method of claim 25 and providing a drive responding to movement of a cam plate indicating feeding of a sheet from the printer to initialize feeding of a card from a card cartridge.

27. The method of claim 26 including securing the card feeder assembly to a base plate of an existing printer.

28. The method of claim 27 including providing slotted mountings for the sheet feed roller shaft on the frame that permits the shaft to move relative to the frame as the frame is secured to the existing printer base plate.

29. A sensor modification for providing a separate signal to an existing sensor of a device, said existing sensor having a light source, and a light receiver that are spaced apart in a gap between the light source and the receiver, the improvement comprising a block positioned between the light source and the receiver, said block blocking light from the light source to the receiver, and said block having a separate light source therein which is controlled by a signal indicating a condition of an attachment to the device.

30. The sensor of claim 29, wherein said separate light source is connected to an existing program used with the attachment device, and wherein the additional device sensor provides a related condition signal to the separate light source in the block.

31. The sensor of claim 30, wherein said device is a printer, and the printer is modified to accept an attachment comprising a transport for a different substrate on which printing is to occur from that of the original printer, and the separate sensor being positioned on the attachment for sensing the position of the different substrate and providing a signal to indicate that the original printer substrate is properly positioned for printing.

32. A control system for a sheet printer having a card feeder assembly attached for printing cards comprising a processor, a communications hub coupled to the processor, a master controller for controlling the card feeder assembly, and a printer controller for controlling a printhead and a printer sheet feeder drive shaft on the printer for initializing feed of a printable sheet to the printer and controlling printer operations, the master controlling and the printer controller being connected to the hub, the processor providing control of the communication hub to couple the master controller to the printer controller for selectively controlling printing through the printer controller.

33. The control system of claim 32 wherein the printer has manual control inputs, the printer manual control inputs being connected to the manual controller.

34. The control system of claim 26 wherein the card feeder assembly includes a signal detector for detecting signals from a card cartridge on the card feeder assembly, the signals from the detector being supplied to the master controller for determining if the cards in the cartridge are acceptable for printing.

35. The control system of claim 32 wherein the printhead is provided with security indicia, the presence of which security indicator indicates the printhead and an ink supply comprise an authorized supply, and a sensor on the printer for sensing the indicia on the printhead and providing a signal to the master controller.

36. The control system of claim 32 wherein the communications hub comprises a USB hub.

37. The control system of claim 32 wherein the printer includes an accessory processing station, and the accessory have controls coupled to the hub and controlled by the master controller.

38. A sensor modification for providing a separate signal to an existing sensor of a device for sensing a condition, said sensor having a signal source and a signal receiver that are spaced apart with a gap between the source and the receiver, the receiver sensing a change of state of a signal from the source, the improvement comprising a block positioned between the source and the receiver, said block blocking signals from the source to the receiver, and said block having a separate signal source therein which is changed in state as controlled by a signal from a separate sensor sensing a condition different from a condition sensed by the existing sensor.
